(19) United States
(12) Patent Application Publication
(10) Pub. No.: US 2002/0171832 A1
(43) Pub. Date: Nov. 21, 2002

(54) Method and apparatus for ensuring precise angular orientation of an optical sensing unit on a housing of an optical imaging device

(75) Inventors: Charles Chuang, Taipei (TW); Sheng-Fuu Lin, Hsinchu (TW); You-Tsai Lin, Hsinchu (TW)

Correspondence Address: Merchant & Gould P.C., P.O. Box 2903, Minneapolis, MN, 55402-0903, US

(73) Assignee: Dynacolor, Inc.

(21) Appl. No.: 09/894,243

(22) Filed: Jun. 27, 2001

(30) Foreign Application Priority Data
May 15, 2001 (TW) 89116556A01

(51) Int. Cl. G01B 11/00

(52) U.S. Cl. 356/399

(57) ABSTRACT

A testing frame supports a test lens unit below a test image piece. A housing of an imaging device is secured to the frame below the lens unit such that an aperture in the housing is registered with the lens unit along an optical axis. An optical sensing unit is loosely mounted on the housing, is adjustable relative to the aperture along transverse axes of a sensing plane, and is rotatable relative to the housing about a rotary axis that is generally aligned with the optical axis. Upon operation, the sensing unit generates image signals corresponding to a captured image of the image piece. The image signals are processed so as to determine a skew angle of the captured image. The angular orientation of the sensing unit relative to the housing is then corrected in accordance with the skew angle.

### BACKGROUND OF THE INVENTION

1. Field of the Invention

The invention relates to optical imaging devices, more particularly to a method and apparatus for ensuring precise angular orientation of an optical sensing unit on a housing of an optical imaging device.

2. Description of the Related Art

During the mass production of optical imaging devices, it is desirable that the image data generated by the imaging devices so-produced will be the same when capturing the image of the same object. To this end, it is important to ensure precise mounting of an optical sensing unit on a housing of the optical imaging device.

In co-pending U.S. patent application Ser. No. 09/689,140, there is disclosed a method and apparatus for ensuring precise alignment between an optical lens unit and an optical sensing unit which are to be mounted on opposite sides of a lens-mounting aperture that is formed in a housing of an optical imaging device. In the aforesaid co-pending U.S. patent application, the optical sensing unit is adjusted with respect to the housing according to X-axis and Y-axis displacement thereof from an optimum position to ensure precise alignment with the optical lens unit.

The difference in the image data that is attributed to a small skew angle difference between the optical sensing units of two optical imaging devices is not easily detected. Since the aforesaid co-pending U.S. patent application is not directed to the detection and correction of the skew angle of an optical sensing unit relative to a housing of the optical imaging device, such angular adjustment currently relies heavily on the judgment of a skilled operator which is prone to human error and is thus unsuitable for the mass production of optical imaging devices having uniform quality.

### SUMMARY OF THE INVENTION

Therefore, the main object of the present invention is to provide a method and apparatus for ensuring precise angular orientation of an optical sensing unit on a housing that is suitable for the mass production of optical imaging devices.

According to one aspect of the invention, there is provided a method for ensuring precise angular orientation of an optical sensing unit on a housing of an optical imaging device. The housing is formed with a lens-mounting aperture, and an optical lens unit is mounted on the housing at one side of the lens-mounting aperture, whereas the optical sensing unit is mounted on the housing at an opposite side of the lens-mounting aperture. The method comprises the steps of:

providing a testing frame that has a downwardly facing test image piece at an upper portion thereof, and that supports a test lens unit below the test image piece, the test image piece having an image thereon that includes two intersecting axes forming four quadrants, each of which is provided with a pattern; and securing the housing to the testing frame below the test lens unit such that the aperture is registered with the test lens unit along an optical axis;

loosely mounting the optical sensing unit on the housing at the opposite side of the aperture such that the optical sensing unit is adjustable relative to the aperture along transverse axes of a sensing plane that is transverse to the optical axis and such that the optical sensing unit is rotatable relative to the housing about a rotary axis that is generally aligned with the optical axis;

operating the optical sensing unit to generate image signals corresponding to a captured image of the test image piece that was received by the optical sensing unit via the test lens unit;

processing the image signals so as to determine a skew angle of the captured image with reference to image data associated with a reference base angle and stored in a previously established correcting database; and

correcting the angular orientation of the optical sensing unit relative to the housing in accordance with the skew angle.

According to another aspect of the invention, there is provided an apparatus adapted for use with an optical imaging device that includes a housing formed with a lens-mounting aperture, an optical lens unit mounted on the housing at one side of the lens-mounting aperture, and an optical sensing unit mounted on the housing at an opposite side of the lens-mounting aperture. The apparatus is adapted to assist in precise mounting of the optical sensing unit on the housing, and comprises:

a testing frame;

a downwardly facing test image niece disposed at an upper portion of the testing frame, the test image piece having an image thereon that includes two intersecting axes forming four quadrants, each of the quadrants being provided with a pattern;

a test lens unit disposed on the testing frame below the test image piece, the testing frame being adapted to secure the housing thereon below the rest lens unit such that the aperture is registered with the test lens unit along an optical axis, the optical sensing unit being loosely mounted on the housing at the opposite side of the aperture such that the optical sensing unit is adjustable relative to the aperture along transverse axes of a sensing plane that is transverse to the optical axis and such that the optical sensing unit is rotatable relative to the housing about a rotary axis that is generally aligned with the optical axis when the housing is secured initially on the testing frame, the optical sensing unit being operable so as to generate image signals corresponding to a captured image of the test image piece that was received by the optical sensing unit via the test lens unit; and

a control device adapted to be coupled to the optical sensing unit for processing the image signals so as to determine a skew angle of the captured image with reference to image data associated with a reference base angle and stored in a previously established correcting database.

Through the assistance of the apparatus of this invention, the angular orientation of the optical sensing unit relative to the housing can be corrected in accordance with the skew angle determined by the control device.

### BRIEF DESCRIPTION OF THE DRAWINGS

Other features and advantages of the present invention will become apparent in the following detailed description of the preferred embodiment with reference to the accompanying drawings, of which:

FIG. 1 illustrates how a correcting database is established in accordance with the method of this invention;

FIG. 2 illustrates an image formed on a test image piece that is used in the setup of FIG. 1;

FIG. 3 is a schematic view showing how an optical sensing unit is mounted on a housing of an optical imaging device in accordance with the method of this invention; and

FIG. 4 illustrates a sensing region of an image captured by the optical sensing unit and processed by a control device in accordance with the method of this invention.

### DETAILED DESCRIPTION OF THE PREFERRED EMBODIMENT

In the following description of the preferred embodiment, the optical imaging device is a camera having a housing that includes front and rear housing parts and that contains control circuitry therein, an optical lens unit mounted threadedly in a lens-mounting aperture at a front side of the front housing part, and an optical sensing unit mounted on a rear side of the front housing part.

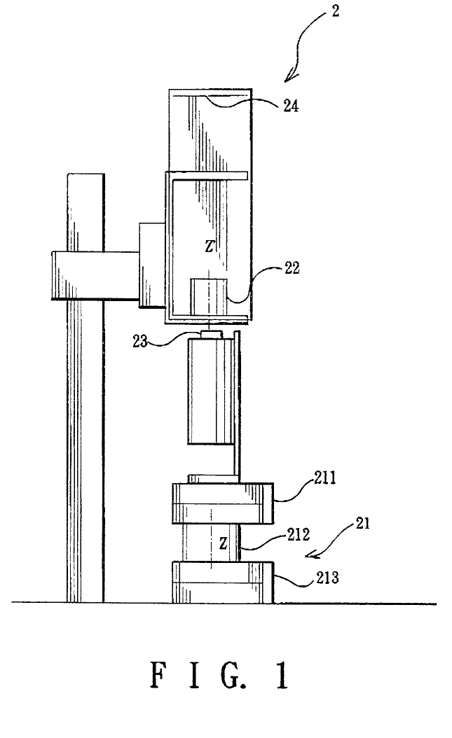

Like the method and apparatus of the aforesaid co-pending U.S. patent application, a correcting database is established in the present invention before the optical sensing unit is mounted securely on the front housing part of the optical imaging device. FIG. 1 illustrates a setup for establishing the correcting database. As illustrated, a testing frame 2 has a downwardly facing test image piece 24 at an upper portion thereof, and supports a test lens unit 22 below the test image piece 22. A test sensing unit 23 is mounted on an adjustable support 21 at a lower portion of the testing frame 2 below the test lens unit 22. By operating the support 21, the test sensing unit 23 can be adjusted relative to the test lens unit 22 along two transverse axes (hereinafter referred to as X and Y axes) of a sensing plane that is transverse to an optical axis (Z′) of the test lens unit 22. Optical measuring devices (not shown) are employed to detect the position of the test sensing unit 23 relative to the test lens unit 22.

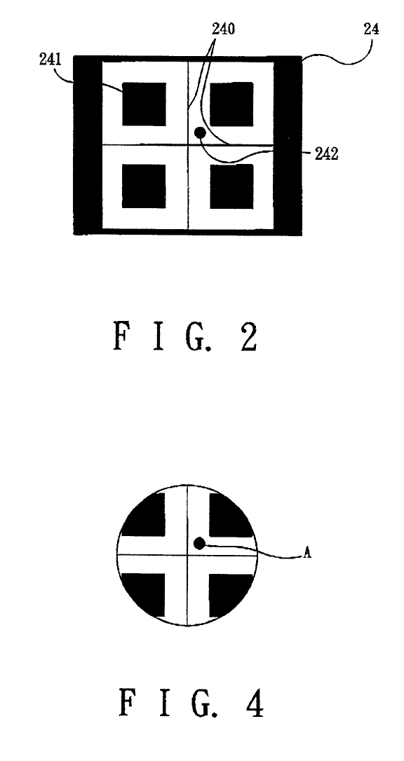

With further reference to FIG. 2, the test image piece 24 has an image thereon. The image includes two intersecting axes 240 of a rectangular or Cartesian coordinate that form four quadrants, each of which is provided with a pattern 241 in the form of a polygon. One of the quadrants is further provided with a position marker 242. The position marker 242 can be dispensed with if the patterns 241 have directional properties.

The test sensing unit 23 is moved repeatedly relative to the test lens unit 22 along the X and Y axes. Each time the test sensing unit 23 is moved to a new position relative to the test lens unit 22, the image signals generated by the test sensing unit 23 and corresponding to a captured test image of the test image piece 24 that was received by the test sensing unit 23 via the test lens unit 22 are detected, and the position information for the test sensing unit 23 generated by the optical measuring devices are recorded to form an entry of the correcting database. Particularly, for each new position of the test sensing unit 23, the boundary information of the patterns 241 in the image captured by the test sensing unit 23 are recorded in the correcting database.

Because screw threads can be formed on the front housing part and the optical lens unit with a high degree of precision, the optical lens unit can be mounted precisely on the front housing part of the optical imaging device.

Unlike the adjustable support of the aforesaid co-sending U.S. patent application, the entire disclosure of which is incorporated herein by reference, the adjustable support 21 of this invention includes an upper platform 211, a lower platform 213 and a rotary seat 212 disposed between and coupling rotatably the upper and lower platforms 211, 213. The lower platform 213 is operable to align a rotary axis (Z) of the rotary seat 212 with the optical axis (Z′) of the test lens unit 22. The upper platform 211 has the test sensing unit 23 disposed thereon and is adjustable to move the test sensing unit 23 relative to the test lens unit 22 along the X and Y axes. The rotary seat 212 is operable so as to rotate the test sensing unit 23 relative to the test lens unit 22.

In the method of this invention, the test sensing unit 23 is moved repeatedly relative to the test lens unit 22 along the X and Y axes while maintaining an angular position of the test sensing unit 23 relative to the test lens unit 22. The angular position of the test sensing unit 23 is hereinafter referred to as a base angle, and the entries of the correcting database are thus generated for the same base angle of the test sensing unit 23. It should be apparent to one skilled in the art that, in actual practice, if the size of the correcting database and the amount of time required for skew angle detection during the subsequent mounting operation can be neglected, the correcting database can include sets of entries, each of which is generated for a corresponding base angle of the test sensing unit 23. One of the base angles is then selected as the reference base angle during the subsequent mounting operation.

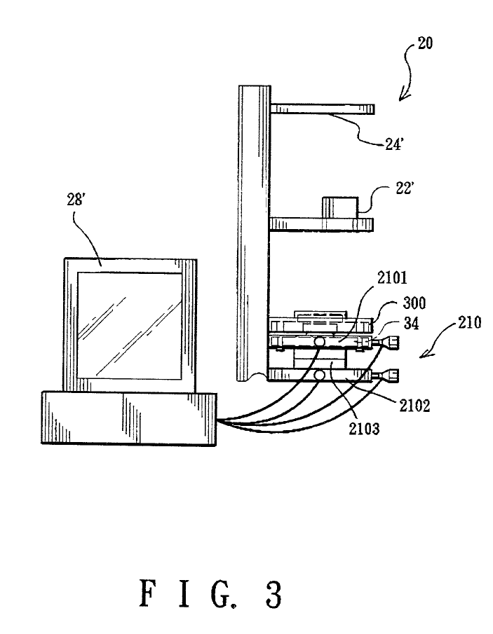

FIG. 3 illustrates how the optical sensing unit 34 is mounted on the front housing part 300 in accordance with the method of this invention. Unlike the setup of FIG. 1, the front housing part 300 is secured to the testing frame 20 below the test lens unit 22′ .The optical sensing unit 34, such as a charge-coupled device, is mounted loosely on the front housing part 300 at a rear side of the lens-mounting aperture with the use of fasteners, and the optical sensing unit 34 is clamped to an adjustable support 210. The support 210 includes an upper platform 2101, a lower platform 2102 and a rotary seat 2103 disposed between and coupling rotatably the upper and lower platforms 2101, 2102. The lower platform 2102 is operable so as to alien a rotary axis of the rotary seat 2103 with the optical axis of the test lens unit 22′ .The upper platform 2l0 has the optical sensing unit 34 disposed thereon and is operable so as to move the optical sensing unit 34 relative to the front housing part 300 along the X and Y axes. Because the fastener holes in the optical sensing unit 34 are slightly larger than the fasteners, the optical sensing unit 34 is adjustable relative to the lens-mounting aperture in the front housing part 300 along the X and Y axes. The rotary seat 2103 is operable so as to rotate the optical sensing unit 34 relative to the front housing part 300.

When mounting the optical sensing unit 34 on the front housing part 300, a captured image of the test image piece 24′ is provided to the optical sensing unit 34 via the test lens unit 22′. Upon operation, the optical sensing unit 34 generates image signals corresponding to the captured image and processed by a control device 28′, such as a personal computer.

Subsequently, the optical sensing unit 34 is adjusted relative to the front housing part 300 along the optical axis so that the captured image has optimum contrast. An appropriate number of washers may be installed by the operator between the optical sensing unit 34 and the front housing part 300 to retain the optical sensing unit 34 at a position for optimum contrast with respect to the optical axis. Since the adjustment of the optical sensing unit 34 along the optical axis proceeds in a manner similar to that described in the aforesaid co-pending U.S. patent application, a detailed description of the same will be dispensed with herein for the sake of brevity.

Thereafter, while viewing the image captured by the optical sensing unit 34 and shown on the control device 28′, the operator operates the adjustable support 210 such that the rotary axis is generally aligned with the optical axis. Then, with reference to the contents of the correcting database, the control device 28′ determines a skew angle of the image captured by the optical sensing unit 34.

With further reference to FIG. 4, when determining the skew angle, the control device 28′ processes the image signals generated by the optical sensing unit 34 to find the intersecting axes in the captured image and to find an intersection point (A) of the intersecting axes. Since many methods for finding the intersection point of ruled lines from a plurality of point information are known to those skilled in the art, a description of the same is omitted herein for the sake of brevity.

Upon determination of the intersection point (A), a sampling region of the captured image is defined by a circular boundary having a predetermined diameter and centered at the intersection point (A). Because the sampling region is located at a central part of the captured, the adverse effects of edge distortion attributed to the test lens unit 22′ can be minimized.

Thereafter, using well-known skew angle determination algorithms, and with reference to the image data associated with the selected reference base angle as stored in the correcting database, pixel points in the sampling region are evaluated by the control device 28′ so as to determine the relative skew angle. The adjustable support 210 is then operated via manual or automatic means to correct the angular orientation of the optical sensing unit 34 with respect to the front housing part 300 in accordance with the skew angle determined by the control device 28′.

After correcting the skew angle of the optical sensing unit 34, the boundary information of the patterns in the image captured by the optical sensing unit 34, with respect to the previously found intersecting axes of the captured image, are determined by the control device 28′ in a manner similar to that described in the aforesaid co-pending U.S. patent application. The boundary information are then compared with the contents of the correcting database in order to determine an actual position of the optical sensing unit 34 along the X and Y axes. Adjustment of the optical sensing unit 34 from the actual position to an optimum position on the X and Y axes as determined from the contents of the correcting database is subsequently performed via manual or automatic means so as to ensure precise alignment with the aperture in the front housing part 300. Upon adjustment of the optical sensing unit 34 to the optimum position relative to the aperture, the fasteners are tightened by the operator to mount the optical sensing unit 34 securely on the front housing part 300. Thereafter, the rear housing part is assembled onto the front housing part 300, and the optical lens unit is mounted threadedly and securely in the aperture at the front side of the front housing part 300 in the manner described beforehand to complete assembly of the optical imaging device.

It has thus been shown that the method and apparatus of this invention can ensure both precise angular orientation of the optical sensing unit on the housing of the optical imaging device and precise alignment between the optical lens unit and the optical sensing unit, and can be applied to the mass production of optical imaging devices having uniform quality.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. In an optical imaging device that includes a housing formed with a lens-mounting aperture, an optical lens unit mounted on the housing at one side of the lens-mounting aperture, and an optical sensing unit mounted on the housing at an opposite side of the lens-mounting aperture, a method for ensuring precise angular orientation of the optical sensing unit on the housing, said method comprising the steps of:
(a) providing a testing frame that has a downwardly facing test image piece at an upper portion thereof, and that supports a test lens unit below the test image piece, the test image piece having an image thereon that includes two intersecting axes forming four quadrants, each of which is provided with a pattern; and securing the housing to the testing frame below the test lens unit such that the aperture is registered with the test lens unit along an optical axis;
(b) loosely mounting the optical sensing unit on the housing at the opposite side of the aperture such that the optical sensing unit is adjustable relative to the aperture along transverse axes of a sensing plane that is transverse to the optical axis and such that the optical sensing unit is rotatable relative to the housing about a rotary axis that is generally aligned with the optical axis;
(c) operating the optical sensing unit to generate image signals corresponding to a captured image of the test image piece that was received by the optical sensing unit via the test lens unit;
(d) processing the image signals so as to determine a skew angle of the captured image with reference to image data associated with a reference base angle and stored in a previously established correcting database; and
(e) correcting the angular orientation of the optical sensing unit relative to the housing in accordance with the skew angle.

2. The method of claim 1, wherein step (d) includes:
(d-1) processing the image signals to find the intersecting axes in the captured image and to find an intersection point of the intersecting axes;
(d-2) defining a sampling region of the captured image that has a circular boundary with a predetermined diameter and centered at the intersection point; and
(d-3) evaluating pixel points in the sampling region using a skew angle determination algorithm and with reference to the image data associated with the reference base angle so as to determine the skew angle.

3. The method of claim 1, wherein the correcting database includes a plurality of sets of image data associated with different base angles, one of the base angles being selected to serve as the reference base angle.

4. The method of claim 1, further comprising, prior to step (a), the step of establishing the correcting database, including the sub-steps of:
with the test lens unit disposed below the test image piece on the testing frame, securing a test sensing unit on the testing frame below the test lens unit such that the test sensing unit is adjustable relative to the test lens unit along the transverse axes and such that the test sensing unit is rotatable relative to the test lens unit; and
while maintaining an angular position of the test sensing unit with respect to the test lens unit and corresponding to the reference base angle, repeatedly adjusting the test sensing unit along the transverse axes, wherein the image data associated with the base angle are obtained each time the test sensing unit is moved to a new position relative to the test lens unit and are recorded to form an entry of the correcting database.

5. The method of claim 1, further comprising the steps of:
(f) processing the image signals to obtain boundary information of the patterns in the captured image;
(g) comparing the boundary information with contents of the correcting database in order to determine an actual position of the optical sensing unit along the transverse axes of the sensing plane;
(h) adjusting the optical sensing unit from the actual position to an optimum position on the sensing plane as determined from the contents of the correcting database; and
(i) mounting securely the optical sensing unit on the housing after adjustment to the optimum position.

6. The method of claim 5, further comprising the step of:
(j) mounting securely the optical lens unit on the housing.

7. The method of claim 1, wherein instep (b), the optical sensing unit is further adjustable relative to the aperture along the optical axis, said method further comprising the steps of, prior to step (d):
adjusting the optical sensing unit along the optical axis so that the captured image has optimum contrast; and
installing an appropriate number of washers between the optical sensing unit and the housing to retain the optical sensing unit at a position for optimum contrast with respect to the optical axis.

8. An apparatus adapted for use with an optical imaging device that includes a housing formed with a lens-mounting aperture, an optical lens unit mounted on the housing at one side of the lens-mounting aperture, and an optical sensing unit mounted on the housing at an opposite side of the lens-mounting aperture, said apparatus being adapted to assist in precise mounting of the optical sensing unit on the housing, and comprising:
a testing frame;
a downwardly facing test image piece disposed at an upper portion of said testing frame, the test image piece having an image thereon that includes two intersecting axes forming four quadrants, each of the quadrants being provided with a pattern;
a test lens unit disposed on said testing frame below said test image piece, said testing frame being adapted to secure the housing thereon below said test lens unit such that the aperture is registered with said test lens unit along an optical axis, the optical sensing unit being loosely mounted on the housing at the opposite side of the aperture such that the optical sensing unit is adjustable relative to the aperture along transverse axes of a sensing plane that is transverse to the optical axis and such that the optical sensing unit is rotatable relative to the housing about a rotary axis that is generally aligned with the optical axis when the housing is secured initially on said testing frame, the optical sensing unit being operable so as to generate image signals corresponding to a captured image of said test image piece that was received by the optical sensing unit via said test lens unit; and
a control device adapted to be coupled to the optical sensing unit for processing the image signals so as to determine a skew angle of the captured image with reference to image data associated with a reference base angle and stored in a previously established correcting database;
whereby, the angular orientation of the optical sensing unit relative to the housing can be corrected in accordance with the skew angle determined by said control device.

9. The apparatus of claim 8, wherein said control device includes:
means for processing the image signals to find the intersecting axes in the captured image and to find an intersection point of the intersecting axes;
means for defining a sampling region of the captured image that has a circular boundary with a predetermined diameter and centered at the intersection point; and
means for evaluating pixel points in the sampling region using a skew angle determination algorithm and with reference to the image data associated with the reference base angle so as to determine the skew angle.

10. The apparatus of Claim 9, wherein said control device further includes:
means for processing the image signals to obtain boundary information of the patterns in the captured image; and
means for comparing the boundary information with contents of the correcting database in order to determine an actual position of the optical sensing unit along the transverse axes of the sensing plane;
whereby, the optical sensing unit can be further adjusted from the actual position to an optimum position on the sensing plane as determined from the contents of the correcting database, and can be mounted securely on the housing after adjustment to the optimum position.

11. The apparatus of claim 8, wherein the correcting database includes a plurality of sets of image data associated with different base angles, one of the base angles being selected to serve as the reference base angle.

12. The apparatus of claim 8, further comprising an adjustable support that includes a rotary seat, and an upper platform disposed on said rotary seat and adapted to be provided with the optical sensing unit thereon, said rotary seat being operable so as to rotate the optical sensing unit relative to the housing, said upper platform being operable so as to adjust the optical sensing unit along the transverse axes of the sensing plane.

13. The apparatus of claim 12, wherein said adjustable support further includes a lower platform coupled rotatably to said upper platform via said rotary seat, and operable so as to align said rotary seat axially with the optical axis.
